(19) United States
(12) Patent Application Publication
(10) Pub. No.: US 2019/0073292 A1
(43) Pub. Date: Mar. 7, 2019

(54) STATE MACHINE SOFTWARE TESTER

(71) Applicant: Panasonic Automotive Systems Company of America, Division of Panasonic Corporation of North America, Peachtree City, GA (US)

(72) Inventors: KATHIRVEL KUPPUSAMY, PEACHTREE CITY, GA (US); RAVIKUMAR RAMAN, PEACHTREE CITY, GA (US); JOHN MORRIS, FAYETTEVILLE, GA (US); SHREE JAISIMHA, SENOIA, GA (US)

(73) Assignee: Panasonic Automotive Systems Company of America, Division of Panasonic Corporation of North America

(21) Appl. No.: 16/120,878

(22) Filed: Sep. 4, 2018

Related U.S. Application Data
(60) Provisional application No. 62/554,085, filed on Sep. 5, 2017.

(51) Int. Cl. G06F 11/36

(52) U.S. Cl. CPC G06F 11/3672

(57) ABSTRACT

Examples of the present disclosure relate to a device, method, and medium storing instructions for execution by a processor for testing state machine software. For example, a state machine software tester device, including a processor, a storage resource with instructions that, when executed on the processor, cause the processor to record a state transition. In an example of the device, the recording can be of a state transition of the component under test, where the state transition is recorded in the log file. In an example, the processor of the device can compare the log file to a number of stored state machine testing permutations. In an example device, the instructions may direct a processor to generate a component testing report for a state transition based on the compared log file and the stored state machine testing permutations.

### CROSS-REFERENCE TO RELATED APPLICATIONS

This application claims the benefit of U.S. Provisional Application No. 62/554,085, filed on Sep. 5, 2017, which the disclosure of which is hereby incorporated by reference in its entirety for all purposes.

### FIELD OF THE INVENTION

The present disclosure generally relates to a method, system, and device for software testing. More specifically, the present disclosure relates to testing for state machine software including state transitions.

### BACKGROUND

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

Software can be modeled and designed in the form of a state machine. As used herein, state machine includes a number of states that the state machine may be in, a number of events that may be detected by the state machine, and a number of actions that a state machine may take. If a detected event satisfies a predetermined criterion, a system using state machine software may execute a state transition where the system moves from a first state to a second state. When a system implementing state machine computing is in a first state and detects a first event, a first action may be taken. When a system implementing state machine computing is in a second state and detects a second event, a second action may be taken.

A state machine component can include class objects that provide functionality of features for the component. These class objects may reside in a thread running within the context of an operating system. The state machine component includes dependency interfaces and provided interfaces. Dependency interfaces identify the services that a component uses from other services, systems, or components. In an example, a dependency interface of a component could include an interface that interoperates with a service provided by a component from a Board Support Package. A Board Support Package is code for a given computer hardware device that makes that device work with the computer's operating system (OS). As used herein, a provided interface refers to the API (Application Program Interface) exposed by the component to external clients.

A software component can include multiple class objects with variables and method functions. Class objects typically react to stimulus to perform an action. The stimulus can stem from either an internal or external means. The stimulus leads to the formation of an event which is processed by the state machine to execute an action function. This may or may not lead to state transition.

### SUMMARY

In an example, a device may be used for testing for state machine software. One example can include a state machine software tester device, including a processor, a storage resource with instructions that when executed on the processor, cause the processor to record a state transition. In an example of the device, the recording can be of a state transition of the component under test, where the state transition is recorded in the log file. In an example, the processor of the device can compare the log file to a number of stored state machine testing permutations. In an example device, the instructions may direct a processor to generate a component testing report for a state transition based on the compared log file and stored state machine testing permutations.

In another example, a method for testing state machine software includes recording a state transition of a component under test, where the state transition is recorded in a log file. The method can also include comparing the log file to a number of stored state machine testing permutations. The method can include generating a component testing report for a state transition based on the compared log file and stored state machine testing permutations.

In another example, a tangible, non-transitory, computer-readable medium can include instructions that, when executed by a processor, direct the processor to test state machine software. In an example, the instructions can direct the processor to record a state transition of a component under test, where the state transition is recorded in the log file. In an example, the instructions can direct the processor to compare the log file to a number of stored state machine testing permutations. In an example, the instructions can direct the processor to generate a component testing report for a state transition based on the compared log file and stored state machine testing permutations.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, wherein:

FIG. 1 is a drawing of an example schematic of a device for testing state machine software;

FIG. 2 is a drawing of a component diagram for testing state machine software;

FIG. 3 is a process flow diagram of an example method to test state machine software;

FIG. 4 is a drawing of an example computer-readable medium storing instructions that when executed on a processor test state machine software; and

FIG. 5 is a drawing of an example schematic for updating and testing a software component using a firmware over the air update.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure are described below. In an effort to provide a concise description of these examples, not all features of an actual implementation are described in the specification. It can be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

As discussed above, a component can have class objects that provide functionality of features which the component aims to achieve. These class objects can in turn be resident in a single thread running within the context of an operating system. State machines can run within the context of a component to implement the feature logic. These are implemented in turn using class objects. We can in turn define state machines as part of behavior modeling. State machines allow for abstract modeling of the behavior that the component provides in order to implement the tangible features to the end user.

As further discussed above, state machines can involve one or more states. States are created based on a behavior considered to be orthogonal or different from an operation. A state can service a set of events and implement a set of respective actions which implements the behavior of the state machine. The action involves executing an associated function sequence and can involve a state transition based on a guard check. As such, although the events exhibit a one to one mapping correspondence with the actions, an action may not be executed if a guard condition is not met when the event is triggered in a state.

Techniques for state machine software testing can use component-based testing of software to implement request and response of functions as well as obtain observer event triggers and the respective state transitions. Testing the state machine and the state transitions allows automation of testing for state machine software that previously used dedicated custom written testing software.

The present disclosure relates to a method and system for software component-based testing. Test driven development methodologies are missing means for behavioral testing of a software component and its respective class objects involving state machine transitions. The present disclosure provides a means to increase the software quality assurance level. The present disclosure provides, at least in part, a means to 1) showcase state machine based complementary testing in different environments like actual target device vs. virtual machine where the testing includes permutations without mocked dependent components alongside actual dependent components. The present disclosure provides, at least in part, a means for 2) execution of test cases in an automated environment. The present disclosure provides, at least in part, a means for 3) uploading test results and creating test defects to test failures in a configuration system. The present disclosure provides, at least in part, a means 4) to provide software quality assurance before deploying new firmware update to target device via USB or Over The Air.

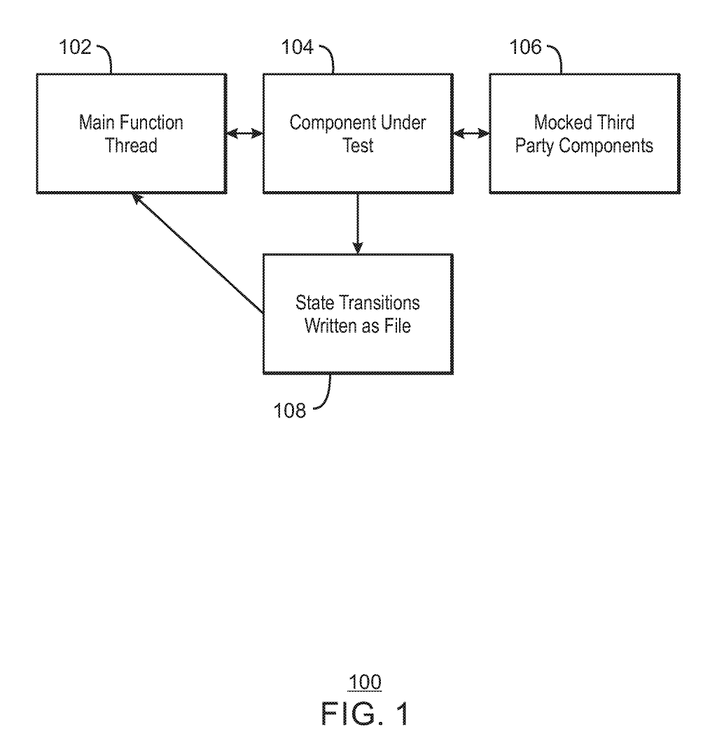

FIG. 1 is a drawing of an example schematic of a device 100 for testing state machine software. The main function thread 102 can be operating in an independent context or in a state determined by a state machine system. The main function thread 102 may execute on a processor of a personal computer system, a server, a distributed system, or other computing resources. The main function thread 102 can include instructions to target and test a component to be identified as a component under test 104 of a state machine. As discussed above, the component to be tested is a state machine component and includes dependency interfaces and provided interfaces as described above. The class objects and the functions of the component under test 104 may be associated with a response or a request that may be triggered by the main function thread 102. A response or request from a main function thread for a class object of the component under test 104 reflects one aspect of state machine testing.

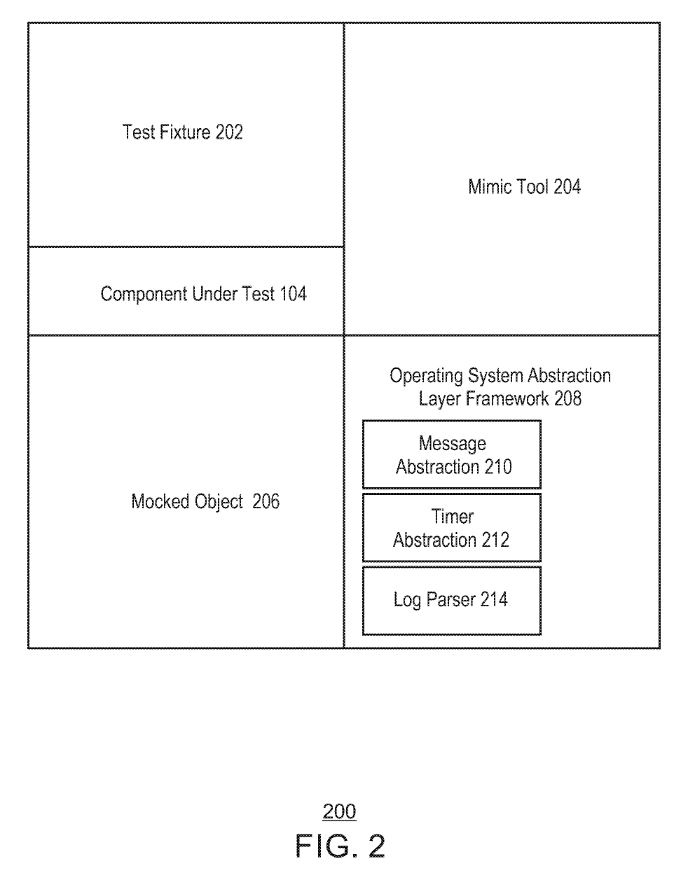

The present disclosure highlights the state machine test and the respective process workflows. For example, software developers can make changes to a software component. A software developer can deliver this software component using integrated development environment tools such as Rational team Concert (RTC). When a software component is delivered to an integration stream, the presently disclosed techniques can use a build engine script to build the software component against a mocked environment set as shown in FIG. 2. The presently disclosed techniques can use a build engine script to test the software component's provided interfaces to confirm if the software component works as intended. In an example, the mocked environment allows for mimicking the required interfaces of the software component in a simulated environment. Exercising the provided interfaces allows for confirming if the class objects and the behavioral model of the class objects is working as expected. If a test of the provided interfaces fails to behave as expected, then a presently disclosed technique includes creating a defect ticket to be sent to the software developer associated with the software component where the defect ticket includes an error report.

In case of a firmware over the air update scenario (FOTA), a software to be can have additive or subtractive updates. Challenges with FOTA updates can arise in deployment to an actual target environment compared to a mocked environment. These issues may include a target device that has different starting software baseline versions. Different starting software may cause a component to malfunction if the component dependencies are not satisfied. In an example, component dependency can include an indication in the target file system of version compatibility of an available dynamic library. In an example, a version compatibility may not be available in the dynamic library, leading to version mismatch in the software component and resulting in test failures.

After applying the FOTA update involving flashing of a new binary to the system, an initial test can be performed whereby a power-on test client can exercise the interfaces provided by the software component. Exercising the interfaces provided by the software component may thereby triggering state machine transitions of the respective class objects and generate a test report. In this scenario, a software component can interact with required interfaces provided by the target system and its respective dynamic libraries during the execution. If the test fails an update, such as a FOTA update by the cloud server, the target device can choose to revert the update and go back to the earlier version due to incompatibility reasons.

In FIG. 1, the main function thread can identify and check state transitions of the component under test 104. In an example, this can be accomplished by identifying other states that may occur in response to events that can be arrived at from the component under test 104. These other states may be identified through reference to the dependency interface of the state machine component. In an example, other states may occur in response to responses from other components not currently being tested. Components not under test may be may be duplicated and tested as a virtual instance at the instruction of the main function thread 102. These duplicated components generated by the main function thread are referred to herein as mocked third party components 106. These mocked third-party components 106 may include state transitions in common with the component under test 104 as well as states and state transitions not present in the component under test 104. State transitions identified from the component under test 104 and the state transitions identified from the mocked third-party components 106 can be stored as state transitions written as a file 108.

The storing of state transitions written as a file 108 enables tabulations of these state transitions to be delivered back to the main function thread 102. The state transitions written as a file 108 also preserves a data log that can be used for identification of failure points of state transitions between states in state machine software.

The testing of state machine software data includes a setup stage, an execution stage, and a tear down stage of these states. As discussed above, the main function thread exercises the setup procedure to configure a mocked third-party component. The main function thread also performs the execute step to interact with the provided interfaces of the component under test 104. As discussed above, the provided interface of the component under test 104 can refer to the API exposed by the component under test. The tear down stage could delete the main function thread and prepare for the next test of the component under test 104.

The results of the setup, execution, and tear down stages can result in the collection of results captured to be sent for correction. In a developer environment, the logs of state machine testing can be used to find potential issues with state transitions and states. Further, coupling of non-mocked components is avoided such that most instructions for state machine software testing occurs in the main function thread. The main function thread can be used in a first device and can simultaneously make requests to a number of components under test simultaneously. As a result of being able to manage these testing request simultaneously, the ability to test components can be applied to a large number of components without a correspondingly large amount of time on component testing.

The deployment of the automated state machine framework can be used in a system undergoing a firmware over-the-air update, where the update is additive instead of subtractive. In a firmware over-the-air scenario, the non-mocked components are used over mock-components to ensure that the update of a component can work properly with its dependent components and its associated versions.

FIG. 2 is a drawing of a component diagram 200 for testing state machine software. Like numbered items are as discussed with respect to FIG. 1.

The component diagram 200 of FIG. 2 includes a testing fixture 202 to register for and receive the event notifications of the component under test 104. The testing fixture 202 may also be used to validate call back function responses by the component under test 104. These call back function responses can be in response to requests from the test fixture 202. The fall back functions validated by the test fixture 202 can enable asynchronous responses stemming from the component under test 104 to the test fixture 202. The requests to the component under test 104 can be achieved through the provided interfaces discussed above.

The test fixture 202 can request that the object that the component under test 104 depends on can be mocked by a mimic tool 204. In an example, the mimic tool 204 can include the open source mimic tools Google Tool (gtool) or Google Mock (gmock). The mocked object 206 can be used by the test fixture 202 to respond to and log state transitions in addition to general request and response data. Event processing by a state of a state machine component under test 104 can stem from the request of the test fixture 202 or be triggered by an observer notification from the third party mocked object 206. In an example, the mocked object 206 can be a dependent stubbed component of the component under test 104.

The API of the provided interfaces of the component under test 104 may include an asynchronous interface to communicate with the test fixture 202 or the mocked object 206. The component under test 104 can use the provided interfaces such as an API to make these communications between states and between component objects. The API of a provided interface of a component under test 104 may also post a message to the operating system abstraction layer framework 208 to be received by message abstraction 210. The timer abstraction 212 of the operating system abstraction layer framework 208 can assist in adding a log time for the arriving message.

The software component under test 104 can provide an interface for external clients to interact with it. The use of this provided interface leads to an example of an external stimulus. When an external client interacts with the software component under test 104, the external client can use the interface provided by the software component under test 104. The use of the interfaces can lead to external stimulus and an event being processed by class objects. The processing by class objects of the event triggered by the external stimulus can lead to behavior software component changes involving state transitions. The external stimulus can also be internal to a software component and can be triggered by an external stimulus. In an example, a software component under test 104 can have an internal event involving an internal timer being set such that upon the timer expiry, the component triggers an internal event transition in the state machine of the software component under test 104.

The log parser 214 can parse the received message and storage in a log file. This parsed log file can be sent to the test fixture 202 for comparison to a number of state machine permutations. Examples of state machine permutations can include an entry event which defines the precondition update for the respective state, and an exit event which defines the cleanup of the state. Another example of a state machine permutation is consume an event within the state and trigger the respective call back function that can trigger a potential state transition. Another example of a state machine permutation is consume an event within the state and trigger the respective call back function without a state transition. Another example of a state machine permutation is consume an event within the state to trigger without a respective call back should the guard check fail. As used herein, a guard check refers to a logical check such as a Boolean expression that evaluates a specific variable of the system rather than a general state condition of the system. Based on the guard check, an action such a state transition may proceed or halt, or the state machine may cease to function.

The deployment of the test fixture 202 can be on a number of platforms. In an example, the test fixture 202 can be implemented in an x86 instruction set architecture, an Armv7 processor core, an ARM7 target for in-car remote testing, or a virtual machine through emulation on a different host.

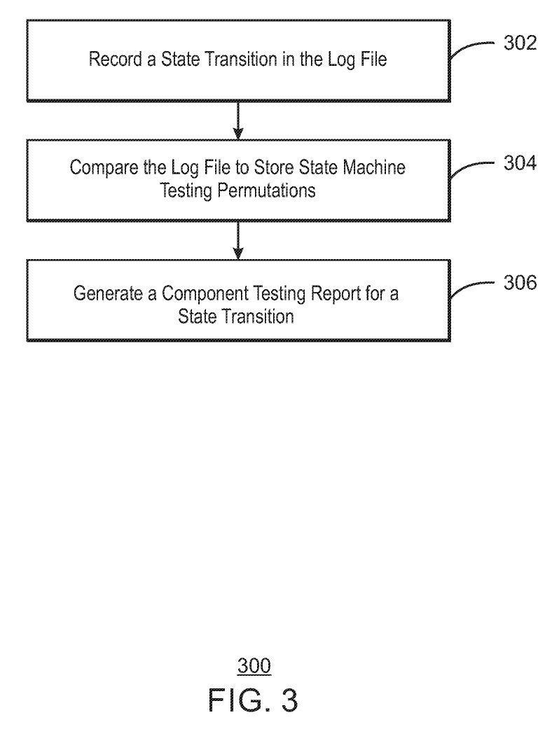

FIG. 3 is a process flow diagram of an example method 300 to test state machine software. Process flow begins at block 302.

At block 302, the method 300 records a state transition of a component under test, where the state transition is recorded in a log file. In an example, the component under test and the dependent components are not mocked. In an example, the component under test and a log file generator are located remotely from a component testing report generator.

At block 304, the method 300 compares the log file to a number of stored state machine testing permutations. At block 306, the method 300 generates a component testing report for a state transition based on the compared log file and stored state machine testing permutations. In an example, the component testing report includes results for a request and response for the functions of the component under test as well as an observer event trigger. In an example, the number of stored state machine testing permutations include at least one of an entry event which defines the precondition update for the respective state, an exit event which defines the cleanup of the state, a consumption of an event within the state to trigger the respective call back function that can trigger a potential state transition, a consumption of an event within the state to trigger the respective call back function without a state transition, or a consumption of an event within the state without a respective call back should the guard check fail.

The method for state machine testing may also include generating a mocked third-party component based on a third-party component that depends from a component under test. The method for state machine testing may also include triggering actions of the component using a provided interface of the component under test. The method for state machine testing may also include registering an event notification received from the component under test. The method for state machine testing may also include approving callback functions to the component under test based on the event notification. The method for state machine testing may also include parsing the state transition recorded in the log file for comparison to the number of stored state machine testing permutations.

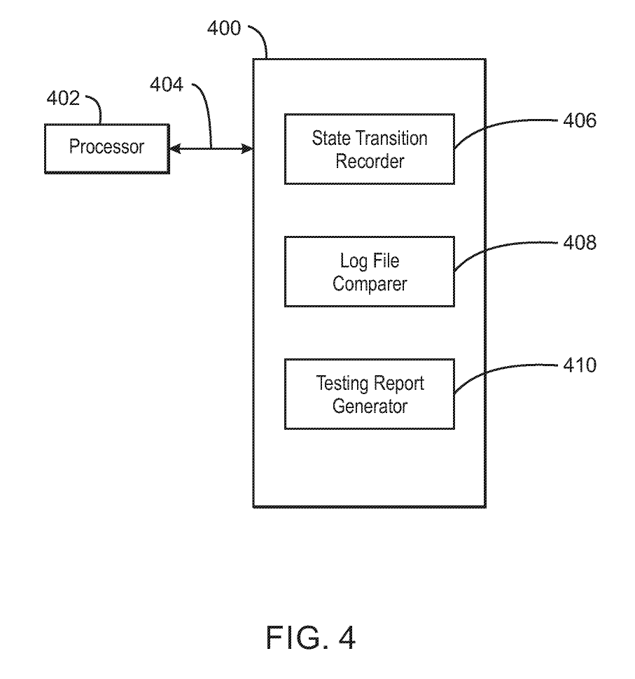

FIG. 4 is a drawing of an example computer-readable medium 400 storing instructions that, when executed on a processor, test state machine software. The tangible, non-transitory, computer-readable medium includes instructions that, when executed by a processor 402, can direct the processor 402 through a bus 404 to test state machine software.

The computer-readable medium can include a state transition recorder 406. The state transition recorder 406 can direct the processor 402 to record a state transition of a component under test, where the state transition is recorded in a log file. In an example, the component under test and the dependent components are not mocked. In an example, the component under test and a log file generator are located remotely from a component testing report generator.

The computer-readable medium 400 can include a log file comparer 408. The log file comparer 408 can direct the processor 402 to compare the log file to a number of stored state machine testing permutations. The computer-readable medium 400 can include a testing report generator 410. The testing report generator 410 can direct the processor 402 to generate a component testing report for a state transition based on the compared log file and stored state machine testing permutations. In an example, the component testing report includes results for a request and response for the functions of the component under test as well as an observer event trigger. In an example, the number of stored state machine testing permutations includes at least one of an entry event which defines the precondition update for the respective state, an exit event which defines the cleanup of the state, a consumption of an event within the state to trigger the respective call back function that can trigger a potential state transition, a consumption of an event within the state to trigger the respective call back function without a state transition, or a consumption of an event within the state without a respective call back should the guard check fail.

The computer-readable medium 400 for state machine testing may also include instructions that, when executed by the processor 402, generate a mocked third-party component based on a third-party component that depends from a component under test. The computer-readable medium 400 for state machine testing may also include instructions that when executed by the processor 402 trigger actions of the component using a provided interface of the component under test. The computer-readable medium 400 for state machine testing may also include instructions that, when executed by the processor 402, register an event notification received from the component under test. The computer-readable medium 400 for state machine testing may also include instructions that, when executed by the processor 402, approve callback functions to the component under test based on the event notification. The computer-readable medium 400 for state machine testing may also include instructions that, when executed by the processor 402, parse the state transition recorded in the log file for comparison to the number of stored state machine testing permutations.

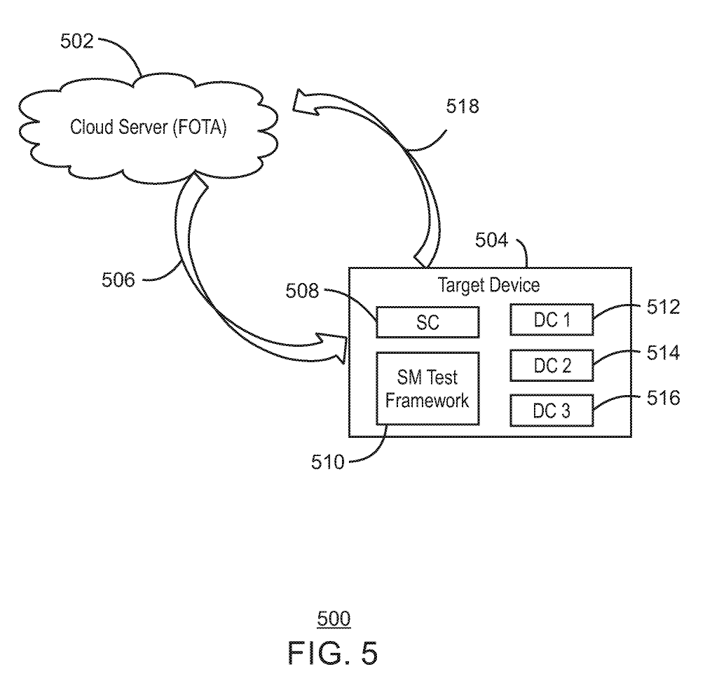

FIG. 5 is a drawing of an example schematic for updating and testing a software component using a firmware over the air update 500.

The cloud server 502 can provide an updated firmware to a target device 504 using a push 506 of the firmware updates to the target device 504. While the update here refers to a FOTA update, other types of software and firmware updates may also follow this example as well. As used herein, a push update, or server push, is a style of communication where the request for a given transaction is initiated by cloud server 502 rather than requested by the target device 504. The push 506 of firmware updates to the target device 504 can relate to a software component 508 of the target device that will be updated. The push update 506 is used here as an example, and updates that are pull updates, additive updates, or subtractive updates would also function in the presently disclosed techniques.

As used herein, the software component 508 can be the focus of the update provided by the cloud server and can be tested by the state machine test framework 510 stored in the target device 504. The state machine test framework can function as earlier described. Specifically, the state machine-based testing may test the functions of the software component 508 but also the state machine transitions of the software component 508.

Testing each of the state machine transitions may rely on dependent component 1 512, dependent component 2 514, and dependent component 3 516. These dependent components may or may not be compatible with the updated software component 508. In the case where a state transition of the software component 508 fails during testing, the version mismatch in the software component may result in a test failure. Feedback 518 from the update can be returned to the cloud server 502 from the target device 504. For example, if the testing by the state machine test framework 510 is successful, then an update can be finalized and feedback 518 with a positive report can be returned. If the test fails an update, such as a FOTA update by the cloud server, the target device can choose to revert the update and go back to the earlier version due to incompatibility reasons while returning feedback 518 with a negative report.

What is claimed is:

1. A state machine software tester system, comprising:
a processor, and
a storage resource with instructions that when executed on the processor, cause the processor to:
record a state transition of a component under test, where the state transition is recorded in a log file;
compare the log file to a plurality of stored state machine testing permutations; and
generate a component testing report for the state transition based on the compared log file and the stored state machine testing permutations.

2. The system of claim 1, comprising instructions for the processor to generate a mocked third-party component based on a third-party component that depends from the component under test.

3. The system of claim 1, comprising instructions for the processor to trigger actions of the component using a provided interface of the component under test.

4. The system of claim 1, comprising instructions for the processor to register an event notification received from the component under test.

5. The system of claim 1, comprising instructions for the processor to approve callback functions to the component under test based on an event notification.

6. The system of claim 1, wherein the component testing report comprises results for a request and response for functions of the component under test as well as an observer event trigger.

7. The system of claim 1, wherein the component under test and dependent components are not mocked.

8. The system of claim 1, wherein the component under test and a log file generator are located remotely from a component testing report generator.

9. The system of claim 1, wherein the plurality of stored state machine testing permutations comprise:
an entry event which defines a precondition update for a state;
an exit event which defines a cleanup of the state;
consumption of an event within the state to trigger a respective call back function that triggers a state transition;
consumption of an event within the state to trigger a respective call back function without the state transition; or
the consumption of the event within the state without a respective call back in response to a guard check failing.

10. The system of claim 1, comprising instructions for the processor to parse the state transition recorded in the log file for comparison to the plurality of stored state machine testing permutations.

11. A method for testing state machine software, comprising:
recording a state transition of a component under test, where the state transition is recorded in a log file;
comparing a log file to a plurality of stored state machine testing permutations; and
generating a component testing report for the state transition based on the compared log file and the stored state machine testing permutations.

12. The method of claim 11, comprising generating a mocked third-party component based on a third-party component that depends from the component under test.

13. The method of claim 11, comprising triggering actions of the component using a provided interface of the component under test.

14. The method of claim 11, comprising registering an event notification received from the component under test.

15. The method of claim 11, comprising approving callback functions to the component under test based on an event notification.

16. The method of claim 11, wherein the component testing report comprises results for a request and response for functions of the component under test as well as an observer event trigger.

17. The method of claim 11, wherein the component under test and dependent components are not mocked.

18. The method of claim 11, wherein the component under test and a log file generator are located remotely from a component testing report generator.

19. The method of claim 11, wherein the plurality of stored state machine testing permutations comprise:
an entry event which defines a precondition update for a state;
an exit event which defines a cleanup of the state;
consumption of an event within the state to trigger a respective call back function that triggers a state transition;
consumption of an event within the state to trigger a respective call back function without the state transition; or
the consumption of the event within the state without a respective call back in response to a guard check failing.

20. The method of claim 11, comprising parsing the state transition recorded in a log file for comparison to the plurality of stored state machine testing permutations.

21. A tangible, non-transitory, computer-readable medium comprising instructions that, when executed by a processor, direct the processor to test state machine software, the instructions to direct the processor to:
record a state transition of a component under test, where the state transition is recorded in the log file;
compare the log file to a plurality of stored state machine testing permutations; and
generate a component testing report for the state transition based on the compared log file and the stored state machine testing permutations.

22. The computer-readable medium of claim 21, comprising instructions for the processor to generate a mocked third-party component based on a third-party component that depends from the component under test.

23. The computer-readable medium of claim 21, comprising instructions for the processor to trigger actions of the component using a provided interface of the component under test.

24. The computer-readable medium of claim 21, comprising instructions for the processor to register an event notification received from the component under test.

25. The computer-readable medium of claim 21, comprising instructions for the processor to approve callback functions to the component under test based on an event notification.

26. The computer-readable medium of claim 21, wherein the component testing report comprises results for a request and response for functions of the component under test as well as an observer event trigger.

27. The computer-readable medium of claim 21, wherein the component under test and dependent components are not mocked.

28. The computer-readable medium of claim 21, wherein the component under test and a log file generator are located remotely from a component testing report generator.

29. The computer-readable medium of claim 21, wherein the plurality of stored state machine testing permutations comprise:
an entry event which defines a precondition update for a state;
an exit event which defines a cleanup of the state;
consumption of an event within the state to trigger a respective call back function that triggers a state transition;
consumption of an event within the state to trigger a respective call back function without the state transition; or
the consumption of the event within the state without a respective call back in response to a guard check failing.

30. The computer-readable medium of claim 21, comprising instructions for the processor to parse the state transition recorded in the log file for comparison to the plurality of stored state machine testing permutations.
